(19) United States
(12) Patent Application Publication
(10) Pub. No.: US 2026/0208079 A1
(43) Pub. Date: Jul. 23, 2026

(54) WATER FILTER AND HOME APPLIANCE WITH WATER FILTER AND METHOD FOR COUPLING WATER FILTER

(71) Applicant: LG Electronics Inc., Seoul (KR)

(72) Inventor: Jongpil KIM, Seoul (KR)

(21) Appl. No.: 19/427,085

(22) Filed: Dec. 19, 2025

(30) Foreign Application Priority Data
Jan. 17, 2025 (KR) 10-2025-0007268

(51) Int. Cl. B01D 35/30; C02F 1/00

(52) U.S. Cl. CPC B01D 35/30; C02F 1/003; B01D 2201/302; B01D 2201/304; B01D 2201/4053; C02F 2201/004; C02F 2307/12; F25D 2323/121

(57) ABSTRACT

A water filter, a home appliance with the water filter, and a method for coupling the water filter. The water filter includes: a filter member; a filter housing configured to receive the filter member; a filter cap configured to seal an opened upper opening of the filter housing and having an inlet portion and an outlet portion protrudingly formed on the filter cap; and a coupling member rotatably provided on the filter cap and configured to be coupled to the head. When the coupling member is rotated relative to the filter cap and the filter housing to be coupled to the head, the inlet portion and the outlet portion move upward and become connected to a flow path of the head.

### CROSS-REFERENCE TO RELATED APPLICATIONS

The present application claims priority under 35 U.S.C. 119 and 35 U.S.C. 365 to Korean Patent Application No. 10-2025-0007268, filed on January 17, 2025, which is hereby incorporated by reference in its entirety.

### BACKGROUND

The present disclosure relates to a water filter, a home appliance with the water filter, and a method for coupling the water filter.

In general, a filter assembly or a home appliance with the filter assembly may include a head provided on a flow path through which water flows, and a filter detachably coupled to the head, the filter having a filter member embedded therein for purification. Depending on the type of the filter member, the filter assembly may provide various purification performances, and may be configured by a combination of multiple filters having different types of filter members.

Such a filter assembly requires periodic replacement in order to maintain purification performance, and may be configured to have a structure that allows easy replacement so that a user may replace the filter at a desired time.

Accordingly, the filter assembly may have a structure that allows convenient coupling and removal, and various coupling structures are being developed to prevent misalignment and ensure accurate coupling between the head and the filter.

Further, a filter assembly has been developed in which a flow path inside the head is switched by rotation of the filter during attachment or detachment, thereby preventing leakage even when the filter is separated from the head.

However, in such a filter assembly, the internal flow path structure of the head for switching the fluid path is complicated. In addition, when the switching of the flow path is repeatedly performed, the durability of the head may be deteriorated, which may result in leakage.

### SUMMARY

An embodiment of the present invention is directed to providing a water filter, a home appliance with the water filter, and a coupling method of the water filter capable of preventing leakage.

An embodiment of the present invention is directed to providing a water filter, a home appliance with the water filter, and a coupling method of the water filter that allow easy attachment and detachment.

An embodiment of the present invention is directed to providing a water filter, a home appliance with the water filter, and a coupling method of the water filter capable of ensuring an accurate coupling state.

The water filter according to an embodiment of the present detachably coupled to a head connected to a water source, the water filter may comprise: a filter member; a filter housing configured to receive the filter member; a filter cap configured to seal an opened upper surface of the filter housing and having an inlet portion and an outlet portion protrudingly formed thereon; and a coupling member rotatably provided on the filter cap and configured to be coupled to the head, wherein, when the coupling member is rotated relative to the filter cap and the filter housing to be coupled to the head, the inlet portion and the outlet portion move upward and become connected to a flow path of the head.

The coupling member may have an opened top and bottom, and wherein the inlet portion and the outlet portion are disposed inside the coupling member.

The inlet portion and the outlet portion may be spaced apart from each other.

the inlet portion and the outlet portion may have different cross-sectional shapes.

The inlet portion and the outlet portion may be formed with an elliptical cross-section, and wherein major axes of the inlet portion and the outlet portion are oriented in different directions.

wherein an operation portion for rotating the coupling member is formed on an outer surface of the coupling member, and

wherein the operation portion is exposed below the head.

A plurality of the operation portions may be formed on the outer surface of the coupling member and radially extend outward from a center of the coupling member.

The operation portion may comprise: a first part extending outward from the outer surface of the coupling member; and a second part protruding upward from the first part and positioned to face a lower end of the head.

The coupling member may comprise: a lower part rotatably coupled to the filter cap; and an upper part extending upward from the lower part and inserted into the head to be coupled thereto, and wherein a coupling portion configured to engage the head is formed on an outer surface of the upper part.

The coupling portion may move upward along a coupling guide of the head when the coupling member rotates.

The upper part may have an outer diameter smaller than an inner diameter of the head, wherein the lower part has an outer diameter larger than the inner diameter of the head and is exposed below the head, and wherein an operation portion for rotating the coupling member is formed on an outer surface of the lower part.

A fastening hook protruding inward may be formed at a lower portion of the coupling member, and wherein a rotation groove configured to receive the fastening hook is formed along a circumference of the filter cap such that the fastening hook moves along the rotation groove when the coupling member rotates.

A fastening groove extending downward and connected to the rotation groove may be formed in the filter cap, and wherein the fastening hook may move into the rotation groove through the fastening groove.

A restricting portion protruding farther than the rotation groove may be formed at a lower end of the fastening groove so as to restrict the fastening hook inserted into the rotation groove.

The fastening hook and the fastening groove may be disposed in plurality at positions facing each other based on a central axis of the water filter.

The water filter may further comprise a rotation member configured to connect the coupling member and the filter cap from outside, wherein the rotation member is fixedly coupled to the coupling member and rotatably coupled to the filter cap.

The rotation member may be formed by coupling a plurality of portions arranged along circumferences of the filter cap and the coupling member.

The home appliance according to an embodiment of the present invention may comprise: a cabinet; a head provided in the cabinet and connected to a water source; and a water filter detachably coupled to the head, wherein the water filter comprises: a filter member; a filter housing configured to receive the filter member; a filter cap configured to seal an opened upper surface of the filter housing and having an inlet portion and an outlet portion protrudingly formed thereon; and a coupling member rotatably provided on the filter cap and configured to be coupled to the head, wherein, when the coupling member is rotated relative to the filter cap and the filter housing to be coupled to the head, the inlet portion and the outlet portion move upward and become connected to a flow path of the head.

A method of mounting a water filter according to an embodiment of the present invention, may comprise: aligning the water filter below a head; inserting a coupling member of the water filter into the head; and rotating the coupling member relative to a filter housing and a filter cap such that the filter cap moves upward, wherein the upward movement of the filter cap causes an inlet portion and an outlet portion provided on the filter cap to be connected to a flow path of the head.

Rotation of the coupling member may stop when upward movement of the inlet portion and the outlet portion is completed.

The details of one or more embodiments are set forth in the accompanying drawings and the description below. Other features will be apparent from the description and drawings, and from the claims.

### BRIEF DESCRIPTION OF THE DRAWINGS

FIG. 1 is a view illustrating a flow path structure for water supply of a refrigerator according to an embodiment of the present invention.

FIG. 2 is an exploded perspective view showing a state in which a water filter is separated from a head according to an embodiment of the present invention.

FIG. 3 is an exploded perspective view of a head body of the head.

FIG. 4 is a bottom view of the head body.

FIG. 5 is a perspective view of the water filter.

FIG. 6 is an exploded perspective view of the water filter.

FIG. 7 is a longitudinal cross-sectional view of the water filter.

FIG. 8 is an exploded perspective view showing a separated state of a coupling member of the water filter.

FIG. 9 is a side view illustrating an upper portion of the water filter from one side.

FIG. 10 is a side view illustrating the upper portion of the water filter from another side.

FIG. 11 is a cutaway perspective view of the coupling member.

FIG. 12 is a perspective view of a filter cap of the water filter.

FIG. 13 is a cutaway perspective view of an upper portion of the water filter.

FIG. 14 is a cutaway perspective view illustrating flow of water in a state in which the water filter is coupled.

FIGS. 15A to 15C are views illustrating stepwise coupling of the water filter.

FIG. 16 is a view illustrating a state of the coupling member inside the head when the coupling member rotates.

FIG. 17 is a view illustrating a state of the coupling member inside the head when the water filter is fully coupled.

FIG. 18 is an exploded perspective view showing a coupling structure of a coupling member, a rotational member, and a filter cap of a water filter according to another embodiment of the present invention.

FIG. 19 is a cross-sectional view of the upper portion of the water filter

### DETAILED DESCRIPTION

Hereinafter, specific embodiments of the present invention will be described in detail with reference to the drawings. However, the present invention is not limited to the embodiments in which the technical concept of the invention is presented, and various other embodiments may be readily proposed within the scope of the concept of the present invention by adding, modifying, or removing components without departing from its essential spirit.

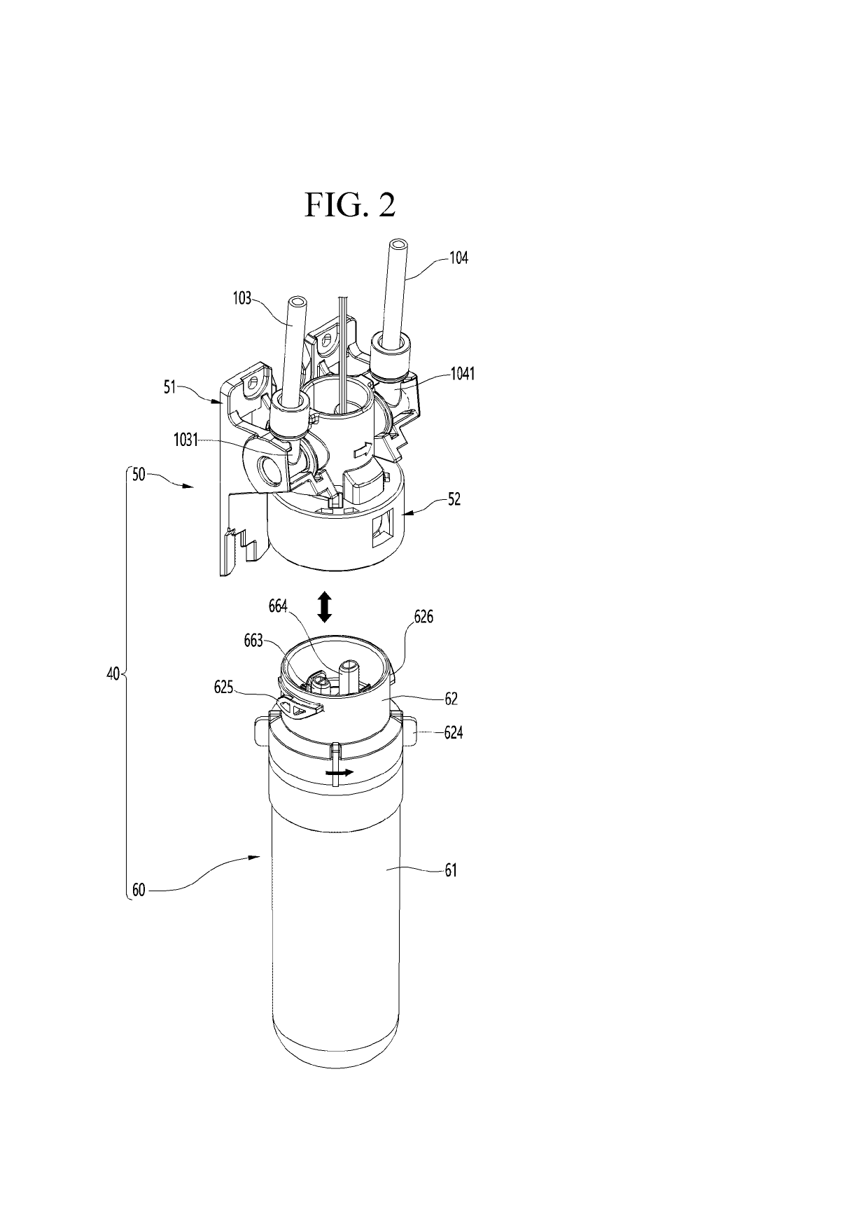

Before the description, directional terms are defined. In an embodiment of the present invention, as shown in FIG. 2, a direction toward the head may be referred to as an upward direction, and a direction toward the water filter may be referred to as a downward direction. A direction toward a mounting member may be referred to as a rearward direction, and a direction moving away from the mounting member may be referred to as a forward direction. In addition, a direction toward a central axis of the filter or head may be referred to as an inward direction, and a direction away from the central axis may be referred to as an outward direction.

Although an embodiment of the present invention is described with reference to a refrigerator among various home appliances, it should be noted in advance that the filter according to the embodiment of the present invention may be applied to various home appliances requiring water purification, such as water purifiers and ice makers, without being limited to a particular structure or shape.

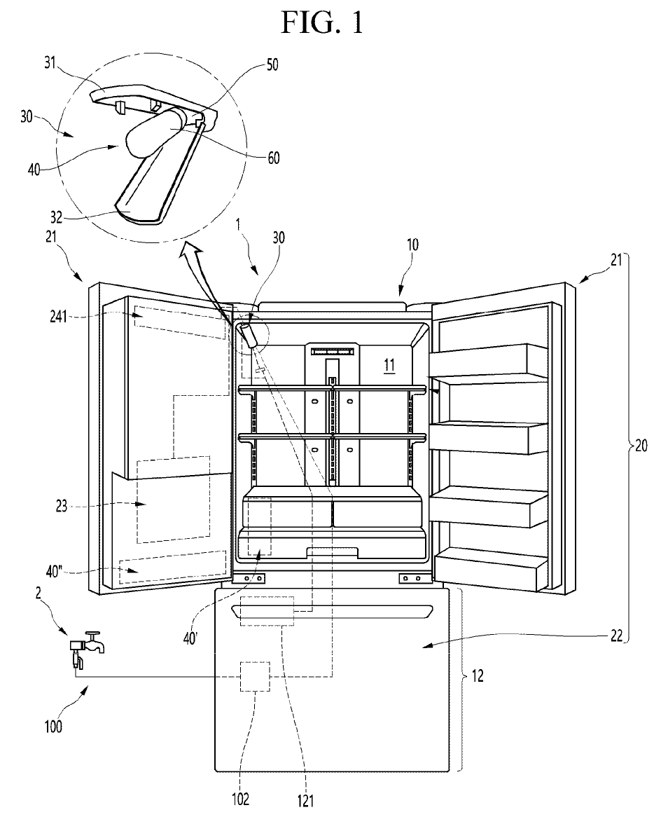

FIG. 1 is a view illustrating a flow path structure for water supply of a refrigerator according to an embodiment of the present invention.

As illustrated, a refrigerator 1 according to an embodiment of the present invention may have an exterior structure defined by a cabinet 10 forming a storage space, and a door 20 configured to open and close the storage space of the cabinet 10.

The storage space may include a refrigerating compartment 11 disposed at an upper portion of the cabinet 10, and a freezing compartment 12 provided at a lower portion of the cabinet 10.

The door 20 may include a refrigerating compartment door 21 and a freezing compartment door 22, which independently open and close the refrigerating compartment 11 and the freezing compartment 12, respectively. The refrigerating compartment door 21 may be provided as a pair on left and right sides and may be configured to open and close the refrigerating compartment 11 by rotation. The freezing compartment door 22 may have a drawer-type structure and may be configured to open and close the freezing compartment 12 by sliding in and out.

The structure of the storage space and the doors that open and close the storage space may vary depending on the type and configuration of the refrigerator. For convenience of explanation and understanding, an embodiment of the present invention is described based on a refrigerator in which the refrigerating compartment is positioned above the freezing compartment and opened and closed by a pair of doors.

Among the pair of refrigerating compartment doors 21, one door may be provided with a dispenser 23 configured to dispense purified water or ice, and an icemaker 241. In addition, an icemaker 121 may also be provided inside the freezing compartment 12.

The refrigerator 1 may be provided with a filter assembly 40 configured to purify water supplied from an external water source 2. In one example, the water source 2 may be tap water. In another example, the water source 2 may be a water tank separately arranged inside or outside the refrigerator 1 in the form of a storage container.

Water supplied from the water source 2 may be purified through the filter assembly 40 and then dispensed through the dispenser 23 or supplied to the icemakers 241 and 121. The water source 2, the filter assembly 40, the dispenser 23, and the icemakers 241 and 121 may be connected through a water supply flow path 100.

The filter assembly 40 may be provided at one corner of a top surface of the refrigerating compartment 11. In another example, the filter assembly 40' may be disposed between storage members such as drawers or shelves in the refrigerating compartment 11, or behind such members so that it is covered. In still another example, the filter assembly 40'' may be installed on the refrigerating compartment door 21.

Meanwhile, a filter device 30 may be provided in the refrigerating compartment 11. The filter device 30 may include a case 31 mounted to the cabinet 10, a cover 32 configured to open and close the case 31, and the filter assembly 40 mounted inside the case 31 and exposed when the cover 32 is opened.

The filter assembly 40 may include a filter 60 and a head 50. When the cover 32 is opened, the filter 60 may be exposed forward and may be easily attached and detached. The filter 60 may be configured for water purification and may be referred to as a water filter or simply a filter.

Hereinafter, the structure of the filter assembly 40 will be described in further detail with reference to the drawings.

FIG. 2 is an exploded perspective view showing a state in which a water filter is separated from a head according to an embodiment of the present invention.

As illustrated, the filter assembly 40 may include a head 50 for mounting the filter assembly 40 and a filter 60 detachably mounted to the head 50.

In one example, the head 50 may include a mounting member 51 configured to fix and mount the filter assembly 40, and a head body 52 rotatably mounted to the mounting member 51, the filter 60 being detachably coupled to the head body 52. Meanwhile, when a structure for mounting the head 50 is already provided in the refrigerator 1, the mounting member 51 may be omitted.

The head body 52 may rotate with respect to the mounting member 51 in a state in which the filter 60 is mounted, thereby enabling easier attachment and detachment of the filter 60. In addition, an inlet pipe fitting 1031 connected to an inlet pipe 103 and an outlet pipe fitting 1041 connected to an outlet pipe 104 may be provided on both sides of the head body 52.

The filter 60 may have an exterior structure defined by a filter housing 61, a filter cap 66, and a coupling member 62. The coupling member 62 may be coupled to the head 50 by rotation. A coupling portion 625 and 626 that engages with the head 50 by rotational coupling may be formed on an outer surface of the coupling member 62. In one example, the coupling portion 625 and 626 may include a first guide protrusion 625 and a second guide protrusion 626 arranged to face each other. Of course, in addition to the pair of guide protrusions 625 and 626, various other structures that allow rotational coupling may also be employed. An operation portion 624 may be provided on the outer surface of the coupling member 62 to allow the coupling member 62 to be rotated so that the filter 60 can be coupled to the head 50.

An inlet portion 663 and an outlet portion 664 protruding upward may be formed on an upper surface of the filter cap 66. Water for purification may flow into the interior of the filter housing 61 through the inlet portion 663, and purified water inside the filter housing 61 may be discharged through the outlet portion 664. The inlet portion 663 and the outlet portion 664 may be provided inside the coupling member 62 and exposed through an open upper portion of the coupling member 62. When the coupling member 62 is rotationally coupled to the head 50, the inlet portion 663 and the outlet portion 664 may move upward and communicate with a flow path inside the head 50, that is, the inlet pipe 103 and the outlet pipe 104.

Hereinafter, the head 50 will be described in further detail with reference to the drawings.

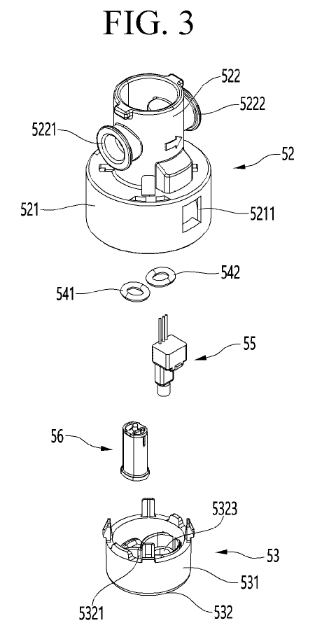

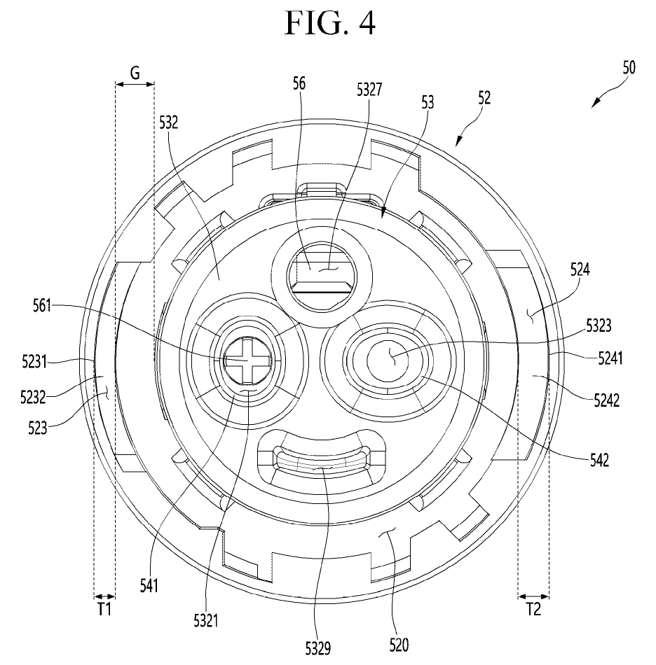

FIG. 3 is an exploded perspective view of a head body of the head, FIG. 4 is a bottom view of the head body.

As illustrated, the head 50 may include the head body 52 to which the filter (60) is detachably mounted.

The head body 52 may include a head upper portion 522 and a head lower portion 521. An inlet pipe connection portion 5221 connected to the inlet pipe fitting 1031, and an outlet pipe connection portion 5222 connected to the outlet pipe fitting 1041, may be formed on both sides of the head upper portion 522. The head body 52 may be rotatably disposed on the mounting member 51 with the inlet pipe fitting 1031 and the outlet pipe fitting 1041 serving as axial supports.

The head lower portion 521 may be formed beneath the head upper portion 522. A lower surface of the head lower portion 521 may be open to form a coupling space 520 in which an upper portion of the filter 60 is received and coupled. A confirmation window 5211 may be opened at a front central portion of the head lower portion 521 to visually confirm completion of the coupling of the filter 60.

An engagement guide 523 and 524 may be recessed into an inner surface of the head lower portion 521 to guide insertion and coupling of the filter 60. In one example, the engagement guide 523 and 524 may include a first guide 523 and a second guide 524. The first guide 523 may guide insertion and coupling of the first guide protrusion 625 formed on the filter 60, and the second guide 524 may guide insertion and coupling of the second guide protrusion 626 formed on the filter 60. The first guide portion 5232 may be formed with a slope or rounded shape.

The first guide 523 may extend upward from a lower end of the head lower portion 521. The first guide 523 may extend to the confirmation window 5211 so that the first guide protrusion 625 moves upward along the first guide 523 to the confirmation window 5211.

The first guide 523 may include a first guide hole 5231 that is open at a lower end of the head lower portion 521 to receive the first guide protrusion 625. The first guide 523 may further include a first guide portion 5232 extending from one end of the first guide hole 5231 toward the confirmation window 5211.

The second guide 524 may be formed at a position facing the first guide 523. The second guide 524 may be formed to correspond in shape to the first guide 523, but may extend in a direction opposite to an extending direction of the first guide 523.

The second guide 524 may include a second guide hole 5241 that is open at a lower end of the head lower portion 521 and configured to receive the second guide protrusion 626. The second guide hole 5241 may be formed in a direction facing the first guide hole 5231. The second guide 524 may further include a second guide portion 5242 extending from one end of the second guide hole 5241 toward a rear central portion of the head lower portion 521, corresponding to the confirmation window 5211.

The second guide portion 5242 may be formed along a periphery of an inner surface of the head lower portion 521 with a slope or rounded shape, and may come into contact with the second guide protrusion 626. The second guide protrusion 626 inserted through the second guide hole 5241 may move while being guided by the second guide portion 5242.

Accordingly, the coupling member 62 may be rotated while the first guide protrusion 625 and the second guide protrusion 626 travel along the first guide hole 5231 and the second guide hole 5241. The filter housing 61 and the filter cap 66 coupled to the coupling member 62 may move vertically without rotation.

Meanwhile, a head inner member 53 may be coupled inside the head body 52. The head inner member 53 may be exposed through an open lower portion of the head body 52. An inlet hole 5321 and an outlet hole 5323 into which the inlet portion 663 and the outlet portion 664 are inserted may be formed in the head inner member 53. The head inner member 53 may further be provided with an inlet ring 541 and an outlet ring 542 for sealing the inlet portion 663 and the outlet portion 664.

In detail, the head inner member 53 may be formed in a circular shape and may include an inner base 532 forming a bottom surface, and an inner wall 531 extending upward along a periphery of the inner base 532.

An inlet hole 5321 and an outlet hole 5323 may be formed in the inner base 532. The inlet hole 5321 and the outlet hole 5323 may each be formed in a shape corresponding to a cross-sectional shape of the inlet portion 663 and the outlet portion 664, respectively. When the first guide protrusion 625 and the second guide protrusion 626 are inserted and engaged into the first guide hole 5231 and the second guide hole 5241, the inlet portion 663 and the outlet portion 664 may naturally be inserted into the inlet hole 5321 and the outlet hole 5323.

Meanwhile, a filter detection device 55 may be provided inside the head body 52 to detect coupling of the filter 60. In one example, the filter detection device 55 may be a sensor configured to detect a change in a magnetic field. A wire 550 connected to the filter detection device 55 may extend upward through the head body 52.

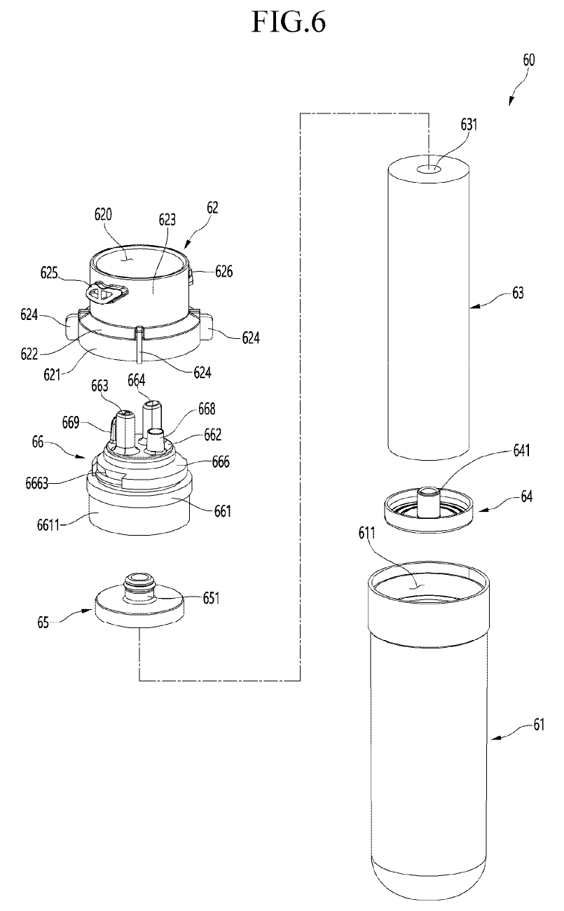

A detection hole 5237 may be formed in the inner base 532 to receive a detection protrusion (668 in FIG. 6), which will be described later. Accordingly, when the filter 60 is mounted to the head 50, the detection protrusion 668 may be inserted into the detection hole 5237, and the filter detection device 55 may detect the detection protrusion 668 to determine whether the filter 60 is properly mounted.

A fixing groove 5329 into which the fixing protrusion 669 is inserted may be formed in the inner base 532. The fixing groove 5329 may be recessed in a shape corresponding to the fixing protrusion 669 so that the fixing protrusion (669 in FIG. 6) may be closely fitted.

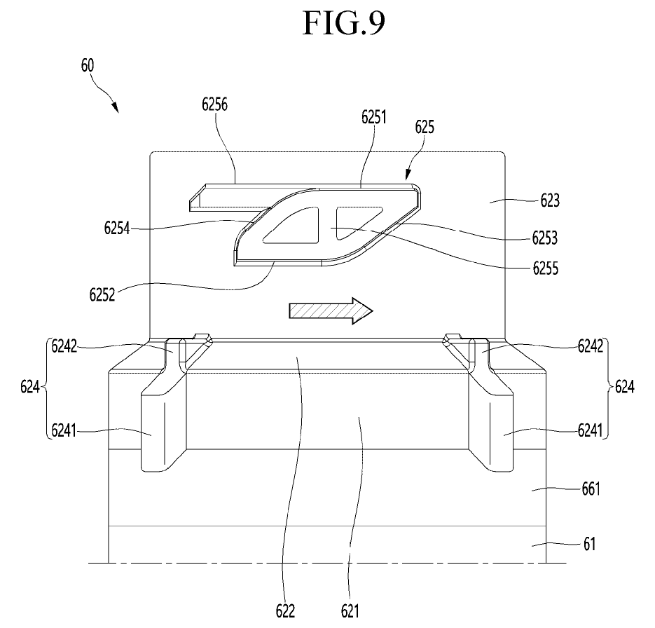

An outer surface of the inner wall 531 may be spaced apart from an inner surface of the head body 52. In this case, a thickness T1 of the first guide portion 5232 may be formed thinner than a thickness T2 of the second guide portion 5242. Accordingly, a gap G between an outer end of the first guide portion 5232 and the outer surface of the inner wall 531 may be formed so that a protrusion extension 6256 of the first guide protrusion (625 in FIG. 9) may be inserted.

In contrast, a gap between an outer end of the second guide portion 5242 and the outer surface of the inner wall 531 may be formed narrower than a thickness of the protrusion extension 6256, thereby preventing insertion of the protrusion extension 6256.

That is, only the corresponding first guide protrusion 625 and second guide protrusion 626 may be inserted into the first guide 523 and the second guide 524, respectively. Accordingly, during coupling of the filter 60, the inlet portion 663 and the outlet portion 664 may be aligned in the correct orientation, thereby fundamentally preventing misalignment of the filter 60.

The inlet portion 663 and the outlet portion 664 may be inserted through the inlet ring 541 and the outlet ring 542 positioned inside the inlet hole 5321 and the outlet hole 5323, thereby preventing leakage between the head 50 and the filter 60.

A flow path communicating with the inlet pipe 103, the outlet pipe 104, and the inlet portion 663 and the outlet portion 664 may be formed inside the head body 52.

A valve 56 may be provided on the flow path inside the head body 52 that connects the inlet pipe 103 and the inlet portion 663. The valve 56 may be disposed above the inlet hole 5321 and above the inlet ring 541. The valve 56 may selectively supply water from the inlet pipe 103 toward the filter 60 and may be opened or closed depending on whether the filter 60 is mounted. In one example, the valve 56 may have a check valve structure. A piston 561 for opening and closing the valve 56 may be positioned inside the inlet hole 5321. Accordingly, when the filter 60 is coupled, the inlet pipe 103 may come into contact with the piston 561 so that water supply to the filter 60 becomes possible.

Hereinafter, the filter 60 will be described in further detail with reference to the drawings.

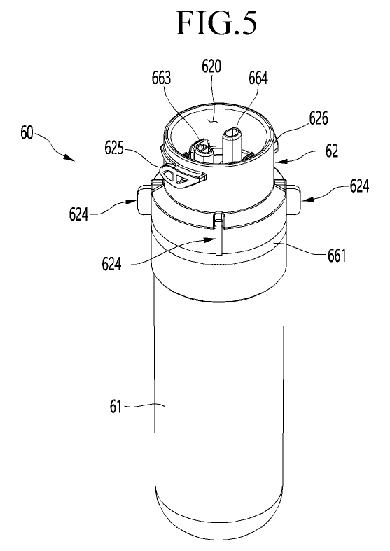

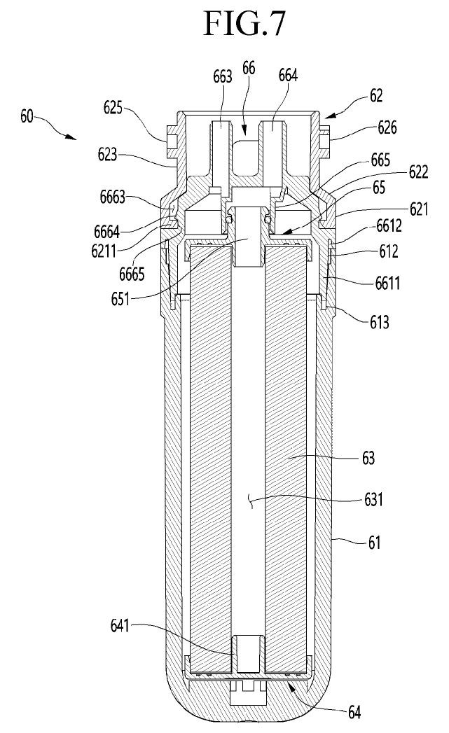

FIG. 5 is a perspective view of the water filter, FIG. 6 is an exploded perspective view of the water filter, FIG. 7 is a longitudinal cross-sectional view of the water filter.

As illustrated, the filter 60 may include a filter member 63 for water purification, a filter housing 61 in which the filter member 63 is accommodated, a filter cap 66 configured to close an open upper surface of the filter housing 61, and a coupling member 62 rotatably coupled to the filter cap 66.

The filter housing 61 may be formed in a cylindrical shape having an open upper surface and may form an exterior appearance of the filter 60. A filter accommodation space 611 in which the filter member is received may be formed inside the filter housing 61.

The filter cap 66 may be coupled to an upper end of the filter housing 61 and may close the filter accommodation space 611. An inlet portion 663 and an outlet portion 664 may protrude upward from an upper surface of the filter cap 66. The inlet portion 663 and the outlet portion 664 may be spaced apart from each other and disposed at left and right sides. A detection protrusion 668 and a rotation protrusion 669 may further be provided on the upper surface of the filter cap 66. The detection protrusion 668 and the rotation protrusion 669 may be omitted when unnecessary.

The inlet portion 663 and the outlet portion 664 may be positioned inside the coupling member 62. The inlet portion 663 and the outlet portion 664 may protrude upward to a height lower than that of the coupling member 62. The detection protrusion 668 and the rotation protrusion 669 may also be positioned inside the coupling member 62.

The filter housing 61 and the filter cap 66 may be formed of a plastic material and may be coupled to each other through ultrasonic welding or rotational welding.

The filter member 63 may be formed in a cylindrical shape having a hollow 631 passing through its center. The filter member 63 may be formed of a porous material and may be configured to purify water passing through the filter member 63. In one example, water positioned outside the filter member 63 may pass through the filter member 63 and flow into the hollow 631, and may then flow upward through the hollow 631 to supply purified water.

The filter member 63 may be constructed using various materials and types, and may be appropriately selected based on required purification performance. In one example, the filter member 63 may include various types of filters such as a membrane filter, a pre-carbon filter, or a sediment filter.

A lower supporter 64 may be provided at a lower surface of the filter member 63. The lower supporter 64 may support the filter 60 from below and may contact a lower surface of the filter housing 61. A lower boss 641 may be formed at a central portion of the lower supporter 64 and may be inserted upward into the hollow 631 to support an inner surface of the filter member 63.

An upper supporter 65 may be provided at an upper surface of the filter member 63. A central portion of the upper supporter 65 may include an upper boss 651 extending in an upward and downward direction. A lower portion of the upper boss 651 may be inserted downward into the hollow 631 to support the inner surface of the filter member 63. An upper portion of the upper boss 651 may be inserted into a nipple receiving portion 665 at a central area of the filter cap 66. An O-ring may be provided around the upper boss 651 to ensure sealing.

The inlet portion 663 may communicate with the interior of the filter accommodation space 611, and water introduced through the inlet portion 663 may flow toward an outer surface of the filter member 63. Water inside the filter housing 61 may be purified while passing through the filter member 63. The purified water passing through the filter member 63 may flow upward through the upper boss 651 into the filter cap 66 and may be discharged through the outlet portion 664.

The coupling member 62 may be rotatably mounted to the filter cap 66. That is, during coupling of the filter 60, the filter housing 61 and the filter cap 66 do not rotate, and only the coupling member 62 rotates to be coupled to the head 50. For this purpose, a rotation groove 6665 may be formed along a perimeter of the filter cap 66. A fastening groove 6663 may further be formed to mount the coupling member 62.

The coupling member 62 may include a lower part 621 connected to the filter cap 66, and an upper part 623 coupled to the head 50.

A fastening hook 6211 may be provided on the lower part 621 so that the upper part 623 and the filter cap 66 may be rotatably coupled to each other. The fastening hook 6211 may be inserted into the rotation groove 6665.

A user operation portion 624 may be formed on the lower part 621 to allow a user to manipulate and rotate the coupling member 62. The user may grasp the operation portion 624 and rotate the coupling member 62, and the rotation state of the coupling member 62 may be visually confirmed through the operation portion 624.

Hereinafter, the coupling member 62 will be described in further detail with reference to the drawings.

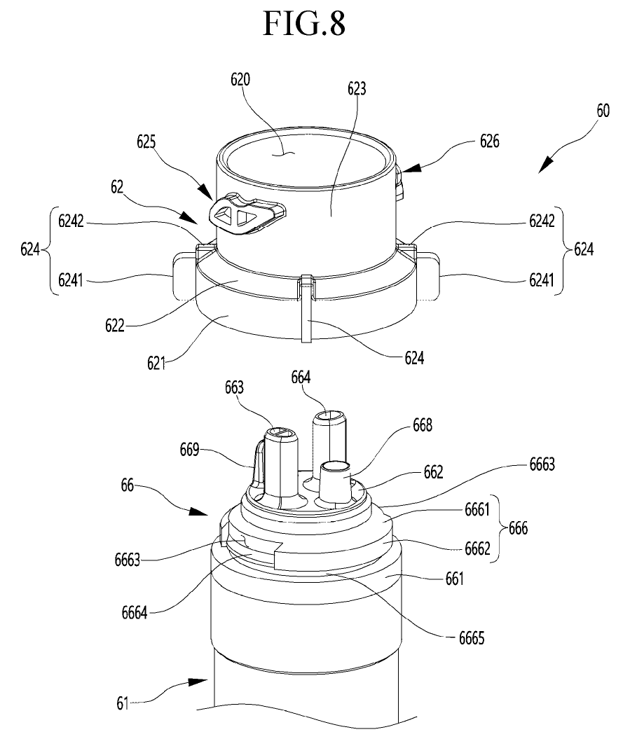

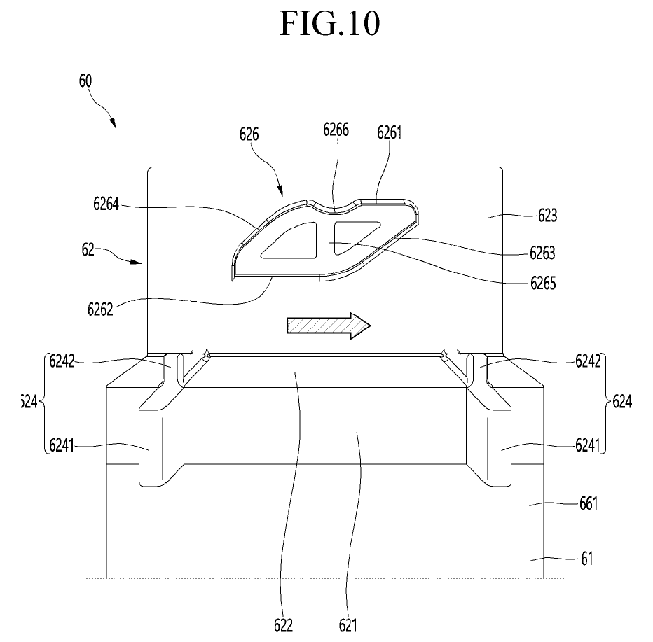

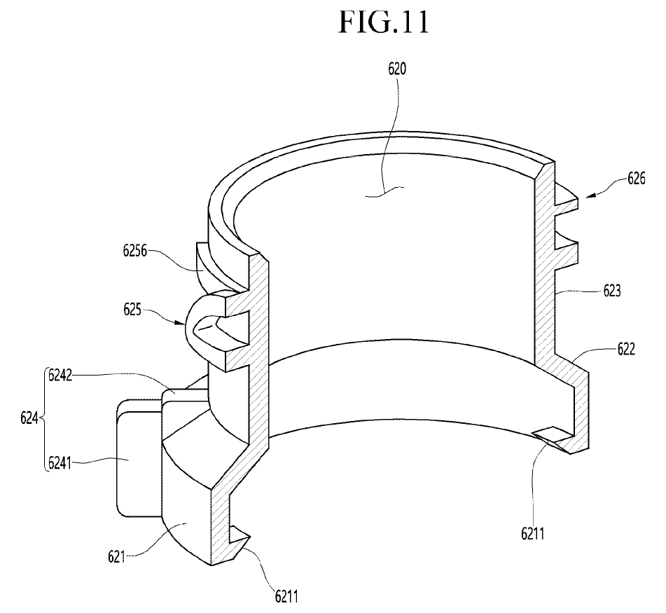

FIG. 8 is an exploded perspective view showing a separated state of a coupling member of the water filter, FIG. 9 is a side view illustrating an upper portion of the water filter from one side, FIG. 10 is a side view illustrating the upper portion of the water filter from another side, FIG. 11 is a cutaway perspective view of the coupling member.

As illustrated, the coupling member 62 may be formed in a cylindrical shape having open upper and lower ends, and a hollow 620 may be formed therein. The coupling member 62 may include a lower part 621 forming a lower portion, and an upper part 623 forming an upper portion.

The upper part 623 may have an outer diameter corresponding to an outer diameter of the filter housing 61 or a lower portion of the filter cap 66. The upper part 623 may be exposed outside below the head 50 and may be formed larger than an inner diameter of the head 50. The lower part 621 may be formed larger than the outer diameter of the upper part 623.

The coupling member 62 may further include an extension portion 622 connecting an upper end of the lower part 621 and a lower end of the upper part 623. The extension portion 622 may be formed with a slope or rounded surface.

The operation portion 624 may be formed on the coupling member 62. Multiple operation portions 624 may be radially disposed around a center of the coupling member 62. The operation portion 624 may extend outward from an outer surface of the coupling member 62, that is, in a direction away from the outer surface of the coupling member 62.

A plurality of operation portions 624 may be arranged at predetermined angular intervals. The operation portions 624 may be exposed in a state protruding outward below the head 50. Accordingly, the rotation state of the coupling member 62 may be visually identified based on the position of the operation portions 624, and the mounting state of the filter 60 corresponding to the rotation state of the coupling member 62 may also be visually confirmed.

The operation portion 624 may include a first portion 6241 and a second portion 6242. The first portion 6241 may protrude outward from an outer surface of the lower part 621. Therefore, a user may grasp the first portion 6241 and rotate the coupling member 62.

The second portion 6242 may form an upper end of the operation portion 624 and may protrude upward from the extension portion 622. The second portion 6242 may be positioned at a location facing a lower perimeter of the head 50. When coupling of the filter 60 is completed, the second portion 6242 may contact or be positioned very close to a lower end of the head 50. Accordingly, a user may determine the coupling completion state of the filter 60 by checking a gap between the second portion 6242 and the lower end of the head 50.

The first portion 6241 and the second portion 6242 may be formed on the same extension line. The first portion 6241 and the second portion 6242 may be formed separately from each other. If necessary, the first portion 6241 and the second portion 6242 may be connected and integrally formed.

Meanwhile, a fastening hook 6211 may be provided at a lower end of the coupling member 62. The fastening hook 6211 may be formed at the lower part 621 and may protrude inward toward the inside of the coupling member 62.

The fastening hook 6211 may extend along the lower end of the coupling member 62 and may be sized to pass through the fastening groove 6663. A plurality of fastening hooks 6211 may be formed along the lower end of the coupling member 62 and may be positioned to face each other based on a center of the coupling member 62. An end of each fastening hook 6211 may be formed to be received inside the rotation groove 6665.

Accordingly, when the coupling member 62 is rotated, the fastening hooks 6211 may move along the rotation groove 6665, and the coupling member 62 may remain coupled to the filter cap 66.

The upper part 623 may extend upward from an upper end of the extension portion 622. The outer diameter of the upper part 623 may be smaller than an inner diameter of the head 50. Therefore, when the filter 60 is mounted, the upper part 623 may be inserted into the head 50 through the open lower surface of the head 50. The upper part 623 may be formed smaller than an outer diameter of the lower part 621. An upper end of the upper part 623 may extend upward beyond the inlet portion 663 and the outlet portion 664.

A coupling portion 625 and 626 may be formed on an outer surface of the upper part 623. The coupling portion 625 and 626 may engage with the engagement guides 523 and 524 of the head 50 during mounting of the filter 60. During rotational operation of the coupling member 62, the coupling portions 625 and 626 may move upward along the engagement guides 523 and 524. By rotation of the coupling member 62, the filter 60 may be coupled to the head 50, and the filter cap 66 may be moved upward so that the inlet portion 663 and the outlet portion 664 may communicate with the flow path inside the head 50.

In one example, the coupling portion 625, 626 may include the first guide protrusion 625 and the second guide protrusion 626. The first guide protrusion 625 and the second guide protrusion 626 may be formed at positions facing each other based on a center of the housing 600 and may protrude outward from an outer surface of the upper part 623.

The first guide protrusion 625 may be formed in a shape insertable into the first guide 523, and the second guide protrusion 626 may be formed in a shape insertable into the second guide 524. The first guide protrusion 625 and the second guide protrusion 626 may be formed in different shapes to prevent misalignment of the filter 60 and ensure accurate installation.

The first guide protrusion 625 may include a first upper portion 6251 and a first lower portion 6252 forming upper and lower surfaces, a first front inclined portion 6253 connecting front ends of the first upper portion 6251 and the first lower portion 6252, and a first rear inclined portion 6254 connecting rear ends of the first upper portion 6251 and the first lower portion 6252. A connecting rib 6255 may further be formed vertically between the first upper portion 6251 and the first lower portion 6252.

The length of the first upper portion 6251 may be formed to correspond to a size of the first guide hole 5231, such that the first guide protrusion 625 may be inserted into the first guide hole 5231. The first front inclined portion 6253 may protrude so as to move while in contact with the first guide portion 5232, thereby facilitating rotational and upward movement of the filter 60.

Meanwhile, a protrusion extension 6256 may be formed at a rear end of the first upper portion 6251 and may extend rearward. A protruding thickness of the protrusion extension 6256 may be smaller than a protruding thickness of the first upper portion 6251. The protruding thickness of the protrusion extension 6256 may also be smaller than a gap G between the head inner member 53 and the first guide portion 5232. Accordingly, when the first guide protrusion 625 is inserted into the first guide hole 5231, the protrusion extension 6256 may be inserted between the first guide portion 5232 and an outer surface of the head inner member 53, enabling insertion and rotational movement of the first guide protrusion 625.

The second guide protrusion 626 may include a second upper portion 6261 and a second lower portion 6262 forming upper and lower surfaces, a second front inclined portion 6263 connecting front ends of the second upper portion 6261 and the second lower portion 6262, and a second rear inclined portion 6264 connecting rear ends of the second upper portion 6261 and the second lower portion 6262. A connecting rib 6265 may further be vertically formed between the second upper portion 6261 and the second lower portion 6262.

The length of the second upper portion 6261 may be formed to correspond to a size of the second guide hole 5241, such that the second guide protrusion 626 may be inserted into the second guide hole 5241. The second front inclined portion 6263 may protrude so as to move while in contact with the second guide portion 5242.

A restriction groove 6266 recessed downward may be formed in the second upper portion 6261. When the housing 600 is fully rotated, the restriction groove 6266 may receive and lock onto a restriction portion protruding from the head 50, thereby securing the filter 60 in position.

Hereinafter, the filter cap 66 will be described in further detail with reference to the drawings.

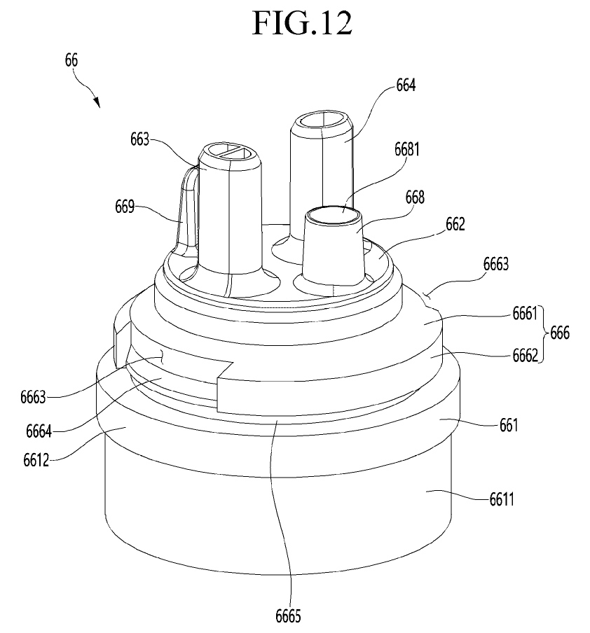

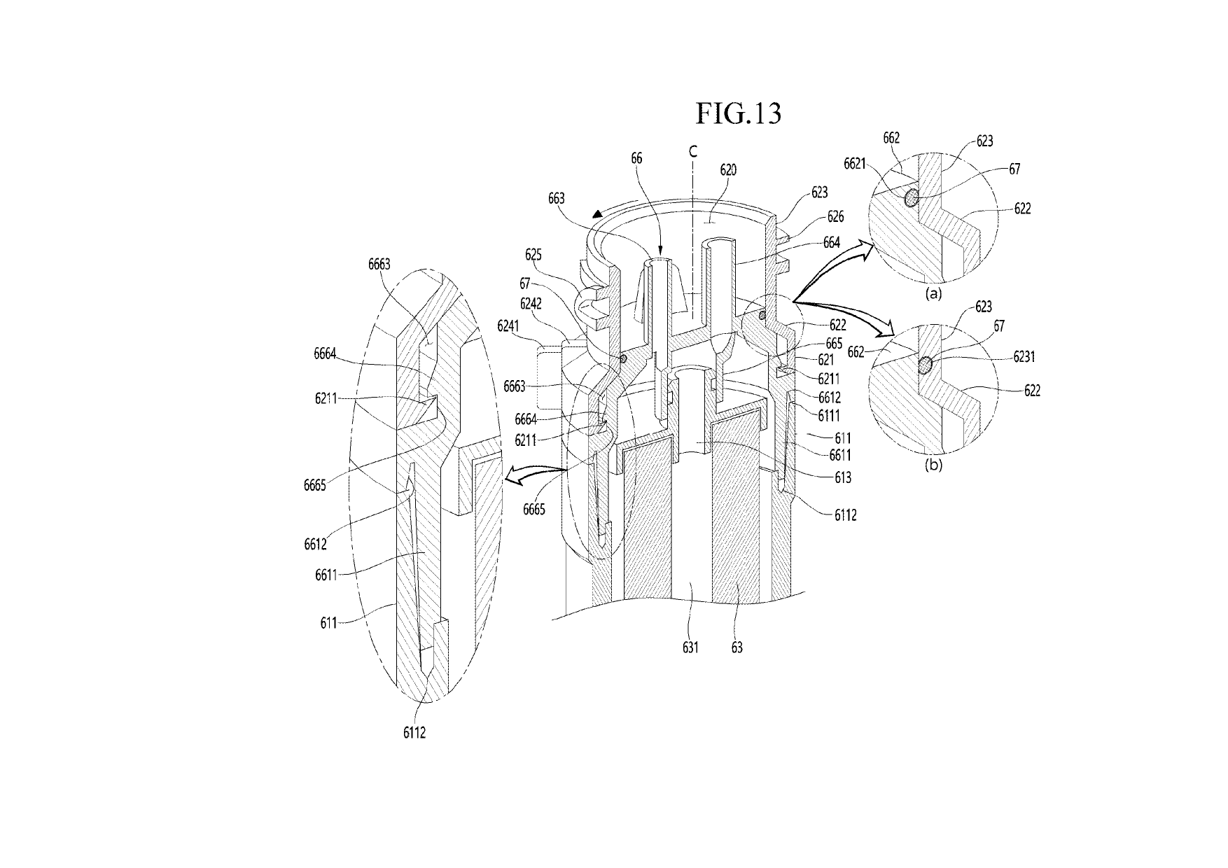

FIG. 12 is a perspective view of a filter cap of the water filter, FIG. 13 is a cutaway perspective view of an upper portion of the water filter.

As illustrated, the filter cap 66 may be formed in a circular shape when viewed from above, and may have an open lower surface. A cap rim 661 may be formed at a lower end of the filter cap 66. The cap rim 661 may contact an upper end of the filter housing 61.

A rim groove 6612 into which an upper end of the filter housing 6111 is inserted may be formed at an inner lower end of the cap rim 661. A rim coupling portion 6611 may extend downward along an inner side of the cap rim 661. A lower end of the rim coupling portion 6611 may be inserted into a housing groove 6112 recessed in an inner surface of the filter housing 61. In this case, an outer surface of the rim coupling portion 6611 may contact an inner surface of the filter housing 61, and the two components may be bonded or welded together through adhesive bonding, ultrasonic welding, or rotational welding.

In a state in which the coupling member 62 is mounted to the filter cap 66, the cap rim 661 may be exposed externally. The cap rim 661 may be positioned between the upper end of the filter housing 61 and a lower end of the coupling member 62.

A cap protrusion 666 may be formed above the cap rim 661. The cap protrusion 666 may be formed to have a smaller diameter than the cap rim 661 and may protrude upward from the cap rim 661. The cap protrusion 666 may include a circumferential surface 6661 positioned above the cap rim 661, and an inclined surface 6662 extending upward from an upper end of the circumferential surface 6661. The circumferential surface 6661 may contact an inner surface of the lower part 621 of the coupling member 62, and the inclined surface 6662 may contact an inner surface of the extension portion 622 of the coupling member 62. Accordingly, a perimeter of the cap protrusion 666 may be in contact with the inner surface of the coupling member 62, thereby preventing foreign substances inside the coupling member 62 from entering between the coupling member 62 and the filter cap 66.

Meanwhile, a rotation groove 6665 may be formed in the filter cap 66. The rotation groove 6665 may be recessed below the cap protrusion 666. The rotation groove 6665 may be formed between the cap rim 661 and the cap protrusion 666. The rotation groove 6665 may extend along the circumference of the filter cap 66 and may be formed around an entire perimeter of the filter cap 66. The rotation groove 6665 may be formed to allow insertion of the fastening hook 6211, and the fastening hook 6211 may move along the rotation groove 6665 during rotation of the coupling member 62.

A fastening groove 6663 may be formed in the filter cap 66. The fastening groove 6663 may form a movement path for the fastening hook 6211 when the coupling member 62 is mounted to the filter cap 66. The fastening groove 6663 may be recessed at a position corresponding to the fastening hook 6211 and may extend in a vertical direction.

In one example, the fastening groove 6663 may extend downward from an upper surface of the cap protrusion 666 to the rotation groove 6665. The fastening groove 6663 may be formed in a number corresponding to the fastening hooks 6211. Accordingly, when the fastening hook 6211 is aligned with the fastening groove 6663 and the coupling member 62 is moved downward, the fastening hook 6211 may be inserted into the rotation groove 6665.

A restriction portion 6664 may protrude from a lower end of the fastening groove 6663. The restriction portion 6664 may restrict the fastening hook 6211, which has passed through the fastening groove 6663 and moved into the rotation groove 6665, from moving upward and separating. In one example, the restriction portion 6664 may be formed such that it becomes inclined outward as it extends downward. A lower end of the restriction portion 6664 may be positioned at an upper end of the rotation groove 6665.

An upper cap surface 662 may be formed above the cap protrusion 666 and may protrude further upward. The upper cap surface 662 may be formed in a size corresponding to an inner diameter of the upper part 623 of the coupling member 62. The inlet portion 663 and the outlet portion 664 may be formed on the upper cap surface 662.

The inlet portion 663 and the outlet portion 664 may be referred to as an inlet nipple and an outlet nipple. The inlet portion 663 and the outlet portion 664 may be spaced apart from each other at positions facing one another and may be arranged side by side between the first guide protrusion 625 and the second guide protrusion 626.

Meanwhile, the inlet portion 663 and the outlet portion 664 may each be formed in an elliptical shape when viewed from above. The major axis of each cross section of the inlet portion 663 and the outlet portion 664 may be oriented in different directions when viewed from above. Accordingly, when the filter 60 is mounted to the head 50, the inlet portion 663 and the outlet portion 664 may be coupled to the inlet hole 5321 and the outlet hole 5323 in a directional manner. That is, based on orientation of the cross-sectional shapes of the inlet portion 663 and the outlet portion 664, misalignment of the filter 60 may be prevented and accurate installation may be ensured.

A rotation protrusion 669 may protrude from the upper cap surface 662. The rotation protrusion 669 may be formed at a position corresponding to the rotation groove 6665. A detection protrusion 668 may also be formed on the upper cap surface 662. The detection protrusion 668 may be formed to be inserted into the detection hole 5327, and a magnet 6681 detected by the filter detection device 55 may be provided on an upper surface of the detection protrusion 668.

Meanwhile, an O-ring 67 may be provided between the filter cap 66 and the coupling member 62. The O-ring 67 may seal a space between the filter cap 66 and the coupling member 62 to prevent water from entering. Specifically, during mounting or removal of the filter 60, remaining water generated from the head 50 may drip and enter the space 620 inside the coupling member 62. In this case, a perimeter of the upper cap surface 662 and an inner surface of the coupling member 62 may be sealed by the O-ring 67, thereby preventing water infiltration. A small amount of remaining water may be stored inside the sealed space 620 of the coupling member 62 without leaking outside the filter 60.

The O-ring 67 may be positioned above a coupling location of the fastening hook 6211. Because the O-ring 67 is positioned higher than the fastening hook 6211, leakage around a coupling region of the fastening hook 6211 may be prevented. In addition, the O-ring 67 may be positioned away from the fastening hook 6211, thereby minimizing interference with rotation of the coupling member 62.

The O-ring 67 may be provided on an upper portion of the filter cap 66 adjacent to the upper cap surface 662 so that water ingress between the filter cap 66 and the coupling member 62 may be blocked from an inlet side.

In one example, as illustrated in FIG. 13(a), a recessed groove 6621 may be formed in a circumferential surface adjacent to the upper cap surface 662, and the O-ring 67 may contact an inner surface of the coupling member 62 while installed in the groove 6621. In another example, as illustrated in FIG. 13(b), a recessed groove 6231 may be formed in a lower portion of the upper part 623 adjacent to the circumference of the upper cap surface 662, and the O-ring 67 may contact a circumferential surface of the filter cap 66 while installed in the groove 6231.

With this structure, water ingress between the filter cap 66 and the coupling member 62 may be prevented, and the coupling member 62 may still rotate smoothly even while the O-ring 67 remains installed.

Hereinafter, a flow state of water in the filter assembly 40 while the filter 60 is mounted will be described in further detail with reference to the drawings.

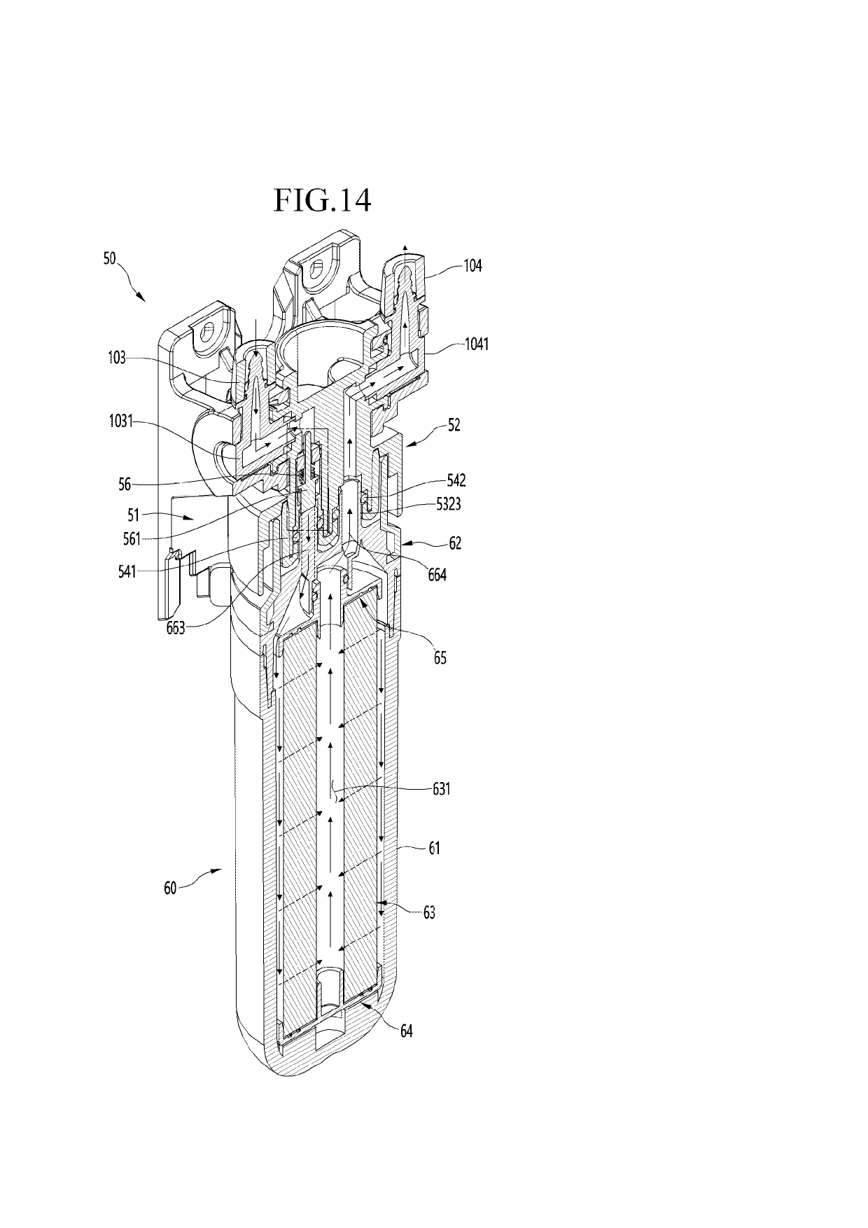

FIG. 14 is a cutaway perspective view illustrating flow of water in a state in which the water filter is coupled.

As illustrated, when the filter 60 is coupled to the head 50, the inlet portion 663 and the outlet portion 664 may be inserted into the inlet hole 5321 and the outlet hole 5323, respectively.

An upper end of the inlet portion 663 may contact the piston 561 to open the valve 56. When the water supply valve 102 is opened, water supplied to the head 50 through the inlet pipe may pass through the valve 56 and be supplied into the filter 60 through the inlet portion 663.

Water introduced into an interior of the filter 60 may flow downward below the filter cap 66 and be guided toward an outer surface of the filter member 63. Water outside the filter member 63 may pass through the filter member 63 and move into the hollow of the filter member 63. During this process, the water may be purified while passing through the filter member 63. The purified water may move upward through the hollow 631 and may be discharged sequentially through the upper boss 651, the nipple receiving portion 665, and the outlet portion 664.

The purified water in the filter 60 may flow to the outlet flow path 5251 through the outlet portion 664 and may be discharged externally through the outlet pipe 104. The purified water discharged from the outlet portion 664 may flow into the outlet pipe 104 through the flow path inside the head 50 and may be supplied to a water dispensing device along the outlet pipe 104.

While the water flows through the filter 60, the perimeters of the inlet portion 663 and the outlet portion 664 may be sealed by the inlet ring 541 and the outlet ring 542 to prevent leakage.

After the filter 60 purifies water for a predetermined period or up to a predetermined usage amount, the filter 60 may be removed from the head 50 and replaced with a new filter. To detach the filter 60 from the head 50, the coupling member 62 may be rotated, causing the filter housing 61 and the filter cap 66 to move downward. During this process, the inlet portion 663 and the outlet portion 664 may move downward due to rotation of the filter 60 and may be separated from the inlet hole 5321 and the outlet hole 5323. The valve 56 may return to a closed state as the inlet portion 663 moves downward and separates, thereby preventing water supplied through the inlet pipe 103 from leaking outside the head 50.

Hereinafter, a mounting process of the filter 60 having the above-described structure will be described in further detail with reference to the drawings.

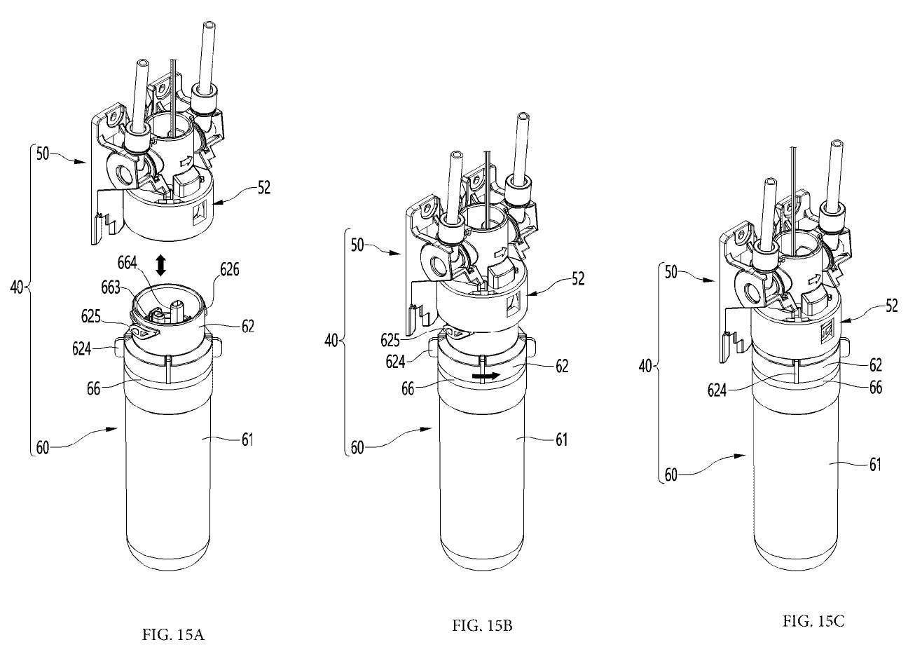

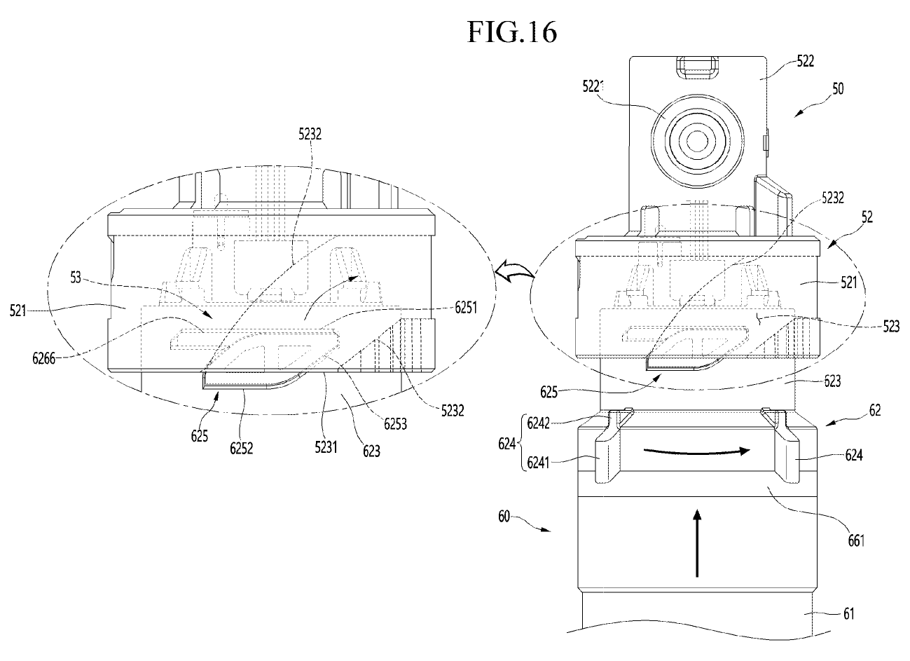

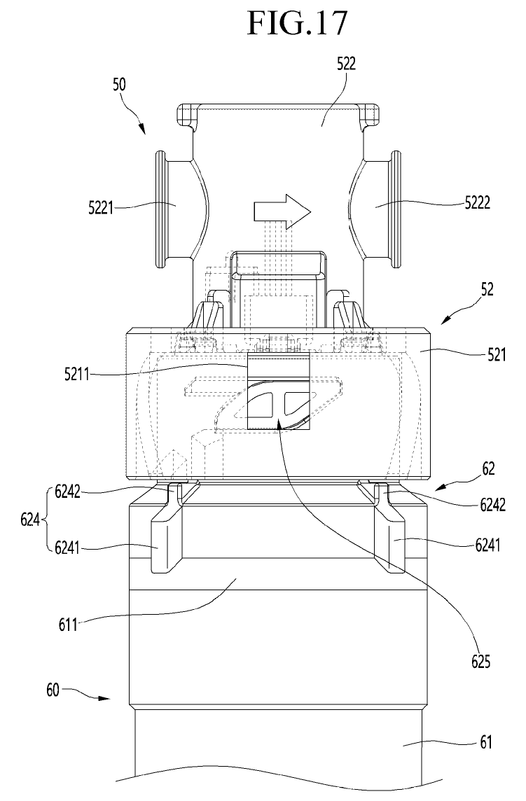

FIGS. 15A to 15C are views illustrating stepwise coupling of the water filter, FIG. 16 is a view illustrating a state of the coupling member inside the head when the coupling member rotates, FIG. 17 is a view illustrating a state of the coupling member inside the head when the water filter is fully coupled.

As illustrated, to mount the filter 60, the filter 60 may first be positioned below the head 50. In this state, the inlet portion 663 and the outlet portion 664 may be aligned such that they can be inserted into the inlet hole 5321 and the outlet hole 5323. In addition, as shown in FIG. 15A, the coupling portions 625 and 626 of the coupling member 62 may also be aligned with the engagement guides 523 and 524 so that the coupling member 62 is positioned in an aligned state.

In one example, in a properly aligned condition, the inlet portion 663 and the outlet portion 664 may be positioned side by side between the first guide protrusion 625 and the second guide protrusion 626. That is, the coupling member 62 may be aligned such that the first guide protrusion 625, the second guide protrusion 626, the inlet portion 663, and the outlet portion 664 are positioned along a common alignment line, and then the filter 60 may be brought toward the lower side of the head 50.

With the filter 60 in the aligned state, the filter 60 may be moved upward for mounting, so that an upper end of the filter 60 may be inserted into the head 50. As shown in FIG. 15B, the coupling portions 625 and 626 may be inserted into the open lower side of the engagement guides 523 and 524, and an upper end of the filter 60 that is, an upper end of the coupling member 62 may be inserted into an interior of the head 50. In this condition, the coupling member 62 may be rotated to move the filter 60 upward and begin coupling the filter 60 to the head 50.

Specifically, as illustrated in FIG. 16, a user may insert the first guide protrusion 625 and the second guide protrusion 626 into the first guide hole 5231 and the second guide hole 5241, respectively, which are opened on a lower surface of the head body 52.

At this time, the first guide protrusion 625 may be structurally prevented from being inserted into the second guide 524, thereby preventing misalignment of the filter 60. In addition, cross-sectional shapes of the inlet portion 663 and the outlet portion 664 may also be configured with directional orientation to prevent incorrect installation.

With the first guide protrusion 625 and the second guide protrusion 626 inserted into the first guide and the second guide 524, the user may rotate the coupling member 62 in a forward direction (counterclockwise when viewed in FIGS. 15A to 15C).

As the coupling member 62 is rotated in the forward direction, the first guide protrusion 625 and the second guide protrusion 626 are moved along the inclined surfaces of the first guide portion 5232 and the second guide portion 5242 within the first guide 523 and the second guide 524. As the first guide protrusion 625 and the second guide protrusion 626 travel along the first guide 523 and the second guide 524, the filter housing 61 and the filter cap 66 may be moved upward.

In addition, the inlet portion 663 and the outlet portion 664 may be progressively inserted into the corresponding inlet hole 5321 and outlet hole 5323, respectively. The fixing protrusion 669 and the detection protrusion 668 may also be progressively inserted into the fixing groove 5329 and the detection hole 5237, respectively.

That is, by rotating only the coupling member 62, the filter housing 61 and the filter cap 66 in the aligned state may be moved upward without rotation, and the insertion of the inlet portion 663 and the outlet portion 664 may automatically occur.

As the rotation of the coupling member 62 continues, the inlet portion 663 and the outlet portion 664 may further move upward while passing through the inlet ring 541 and the outlet ring 542, respectively. Accordingly, the inlet portion 663 and the outlet portion 664 may be sealed within the inlet hole 5321 and the outlet hole 5323.

As shown in FIG. 15C, when the coupling member 62 is rotated by a predetermined angle, the filter housing 61 and the filter cap 66 may reach their maximum upward position, and the insertion of the inlet portion 663 and the outlet portion 664 may be completed.

When the coupling member 62 is rotated forward by the predetermined angle, the first guide protrusion 625 and the second guide protrusion 626 may move to the upper ends of the first guide 523 and the second guide 524. At this point, the end of the inlet portion 663 may be fully inserted inside the inlet hole 5321 and the outlet hole 5323, and may come into contact with the valve 56 to open the valve 56.

In addition, the fixing protrusion 669 and the detection protrusion 668 may also be further inserted into the fixing groove 5329 and the detection hole 5237, respectively. When the detection protrusion 668 is fully inserted into the detection hole 5237, the filter detection device 55 may detect it and open the water supply valve 102, thereby initiating water supply toward the filter 60.

In detail, as illustrated in FIG. 17, when the filter 60 is fully coupled to the head body 52, the first guide protrusion 625 and the second guide protrusion 626 may move laterally at the upper ends of the first guide 523 and the second guide 524, and remain in a fixed state.

At this time, the first guide protrusion 625 may be positioned within the confirmation window 5211. The confirmation window 5211 is open toward the front, and the first guide protrusion 625 may be exposed forward through the confirmation window 5211. Accordingly, the user may visually confirm that the coupling rib 6255 is positioned at the center of the confirmation window 5211, thereby confirming that the filter 60 is completely mounted to the head 50.

Specifically, at the moment when the filter 60 is fully secured to the head body 52, the restriction groove 6266 and the restriction portion formed in the head 50 may interlock with each other. The user may additionally determine that the filter 60 has been properly mounted to the head 50 by perceiving a locking sound or vibration generated at this time.

Additionally, the rotational position of the operation portion 624 allows the user to identify the rotation amount of the coupling member 62 and visually confirm that the filter 60 has been fully mounted to the head 60. Further, when the upper end of the operation portion 624 comes into contact with the lower end of the head 60, the user may visually verify that the filter has been completely mounted to the head 60.

Once the inlet portion 663 and the outlet portion 664 are fully inserted into the inlet hole 5321 and the outlet hole 5323, the internal flow path of the filter 60 and the internal flow path of the head 50 may be brought into communication with each other. Thereafter, the valve 56 and the water supply valve 102 may be opened, allowing water to be supplied to the filter 60 for purification and purified water to be delivered to the water dispensing device.

Meanwhile, when the filter 60 is used for a predetermined period of time or after a predetermined amount of water has passed through, its performance may deteriorate. Accordingly, replacement may be required, and for replacement, the filter 60 may be removed from the head 60 by reversing the above-described coupling procedure.

That is, when the coupling member 62 is rotated in the reverse direction while the filter 60 remains coupled to the head, the filter cap 66 and the filter housing 61 may move downward without rotating. As a result, the inlet portion 663 and the outlet portion 664 may disengage from the inlet hole 5321 and the outlet hole 5323. At this time, the valve 56 may return to the closed state so that leakage does not occur during the removal process of the filter 60.

Meanwhile, the present invention is not limited to the foregoing embodiment, and various other embodiments are also possible. Hereinafter, another embodiment of the present invention will be described with reference to the drawings. Among the components of the other embodiment of the present invention, configurations identical to those of the previously described embodiment may have their detailed description and illustration omitted, and may be described using the same reference numerals. In other words, only the structural differences from the foregoing embodiment will be described below, and the components not specifically described may be identical to those of the previously described embodiment. Therefore, components not illustrated or not described in detail may be referenced from the drawings associated with the foregoing embodiments.

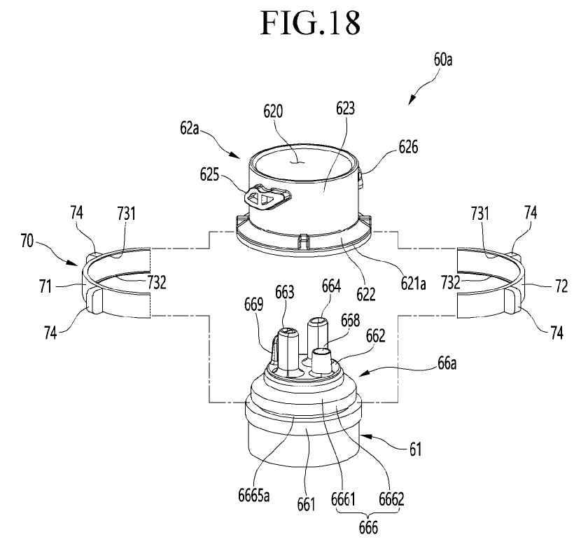

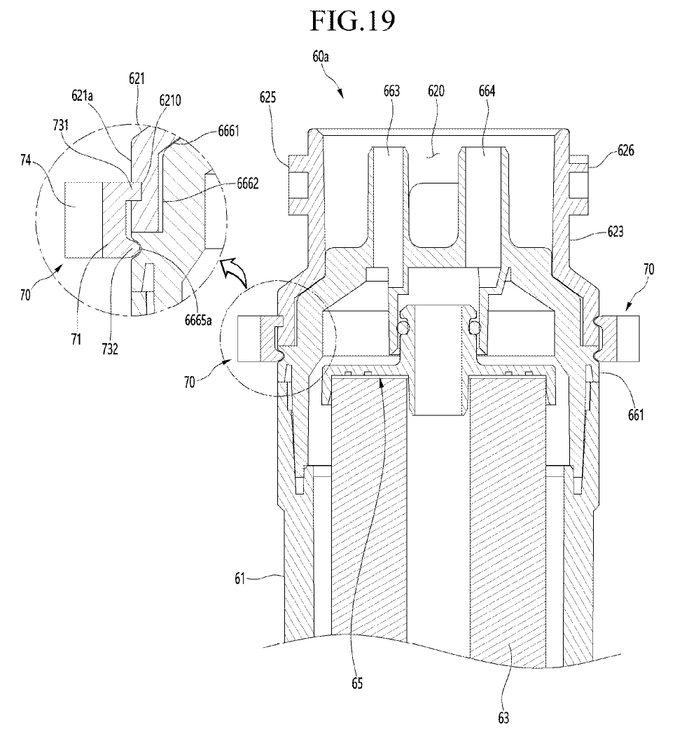

FIG. 18 is an exploded perspective view showing a coupling structure of a coupling member, a rotational member, and a filter cap of a water filter according to another embodiment of the present invention, and FIG. 19 is a cross-sectional view of the upper portion of the water filter.

As illustrated, a filter 60a according to another embodiment of the present invention may have its exterior defined by the filter housing 61, a filter cap 66a, a coupling member 62a, and a rotation member 70.

A filter member 63 may be provided inside the filter housing 61, and an upper supporter 65 may be installed on the upper side of the filter member 63. The upper boss 651 of the upper supporter 65 may be inserted into and secured within the nipple receiving portion 665 of the filter cap 66a.

The filter cap 66a may seal the open upper end of the filter housing 61 and may be coupled to the upper end of the filter housing 61 by adhesive bonding or welding. An inlet portion 663 and an outlet portion 664 may be formed on the upper surface of the filter cap 66a and may protrude upward. In addition, a sensing protrusion 668 and a rotation protrusion 732 may also be provided on the upper surface of the filter cap 66a.

A cap rim 661 may be formed along the circumference of the filter cap 66a, and a cap protrusion 666 may be formed above the cap rim 661. A rotation groove 6665a may be formed below the cap protrusion 666. The lower portion of the rotation member 70 may be rotatably coupled to the rotation groove 6665a.

The coupling member 62a may be seated above the filter cap 66a. The coupling member 62a may include a lower part 621 and an upper part 623 on which the coupling portions 625 and 626 are formed. The lower part 621 and the upper part 623 may be connected to each other through an extension part 622. A fixing groove 621a may be formed at the lower end of the lower part 621. The fixing groove 621a may receive and fixedly couple the upper portion of the rotation member 70.

The rotation member 70 may connect the coupling member 62a to the filter cap 66a. The rotation member 70 may be fixedly coupled to the coupling member 62a, and rotatably coupled to the filter cap 66a. Accordingly, when the rotation member 70 is operated by rotation, the filter cap 66a and the filter housing 61 may remain stationary, and the rotation member 70 and the coupling member 62a may rotate together.

In detail, the rotation member 70 may be formed in a circular ring or band shape. The rotation member 70 may be configured with two portions: a first rotation member 71 and a second rotation member 72, which may be coupled together to form a circular rotation member 70. The first rotation member 71 and the second rotation member 72 may have their ends joined to each other by adhesive bonding or welding. In the coupled state of the first rotation member 71 and the second rotation member 72, the rotation member 70 may also be coupled to the filter cap 66a and the coupling member 62a.

A fixing protrusion 731 may be formed at an upper portion of the inner surface of the rotation member 70. The fixing protrusion 731 may be inserted into the fixing groove 621a. The fixing protrusion 731 and the fixing groove 621a may be press-fitted together. The fixing protrusion 731 and the fixing groove 621a may be bonded by adhesive or welded by ultrasonic welding. The fixing protrusion 731 and the fixing groove 621a may be formed in a polygonal shape or in other mutually engagable shapes to provide a firm coupling. Accordingly, the rotation member 70 may be coupled so as to rotate together with the coupling member 62a. If required, the rotation member 70 and the coupling member 62a may be fastened together using a separate fastening member.

A rotation protrusion 732 may be formed at a lower portion of the inner surface of the rotation member 70. The rotation protrusion 732 may be inserted into the rotation groove 6665a. The rotation protrusion 732 may be formed so as to move along the rotation groove 6665a. Therefore, the rotation member 70 may rotate while the rotation protrusion 732 remains inserted within the rotation groove 6665a.

An operation portion 74 may be formed on the outer surface of the rotation member 70 so as to protrude outward. A plurality of the operation portions 74 may be provided and may be arranged at predetermined intervals.

During rotation of the rotation member 70 when the filter 60a is mounted to the head 60, the filter cap 66a and the filter housing 61 may move upward without rotating. The inlet portion 663 and the outlet portion 664 may connect to the flow path of the head 60a so that water supplied to the filter 60a may be purified and the purified water may be discharged.

According to an embodiment of the present invention, the water filter, the home appliance with the water filter, and the coupling method of the water filter may provide the following effects.

When only a coupling member is rotated during coupling and removal of the water filter, a filter housing and a filter cap may move vertically without rotation, such that an inlet portion and an outlet portion may be connected or disconnected.

Therefore, the movement of water at the inlet portion and the outlet portion during the coupling process of the water filter may be minimized, and therefore leakage occurring during the coupling process of the water filter may be prevented.

Since the user may perform coupling and removal of the water filter by rotating only a coupling member without rotating the water filter itself, the attachment and detachment operation of the water filter is simplified, thereby improving convenience in replacement and maintenance.

The completion of the coupling of the water filter may be determined through a rotation angle or a rotational position of the coupling member, and the coupling state of the water filter may be visually confirmed with ease.

In addition, since the coupling member may no longer rotate when the inlet portion and the outlet portion are fully inserted, the proper coupling of the water filter may be ensured by rotating the coupling member until further rotation is not possible, thereby guaranteeing an accurate installation state of the water filter.

What is claimed is:

1. A water filter configured to be detachably coupled to a head that is connected to a water source, the water filter comprising:
a filter member;
a filter housing configured to receive the filter member;
a filter cap configured to seal an opened upper opening of the filter housing and having an inlet portion and an outlet portion protrudingly formed on the filter cap; and
a coupling member rotatably provided on the filter cap and configured to be coupled to the head,
wherein the inlet portion and the outlet portion are configured to, based on the coupling member being rotated relative to the filter cap and the filter housing to be coupled to the head, move upward and connect to a flow path of the head.

2. The water filter of claim 1,
wherein the coupling member has an opened top and bottom, and
wherein the inlet portion and the outlet portion are disposed inside the coupling member.

3. The water filter of claim 2,
wherein the inlet portion and the outlet portion are spaced apart from each other.

4. The water filter of claim 3,
wherein the inlet portion and the outlet portion have different cross-sectional shapes.

5. The water filter of claim 3,
wherein the inlet portion and the outlet portion are formed with an elliptical cross-section, and
wherein major axes of the inlet portion and the outlet portion are oriented in different directions.

6. The water filter of claim 1,
wherein an operation portion for rotating the coupling member is formed on an outer surface of the coupling member, and
wherein the operation portion is exposed below the head.

7. The water filter of claim 6,
wherein the operation portion is one of a plurality of operation portions that are provided on the outer surface of the coupling member and radially extend outward from a center of the coupling member.

8. The water filter of claim 7,
wherein the operation portion comprises:
a first part extending outward from the outer surface of the coupling member; and
a second part protruding upward from the first part and positioned to face a lower end of the head.

9. The water filter of claim 1,
wherein the coupling member comprises:
a lower part rotatably coupled to the filter cap; and
an upper part extending upward from the lower part and inserted into the head to be coupled to the head, and
wherein a coupling portion configured to engage the head is formed on an outer surface of the upper part.

10. The water filter of claim 9,
wherein the coupling portion moves upward along a coupling guide of the head when the coupling member rotates.

11. The water filter of claim 9,
wherein the upper part has an outer diameter smaller than an inner diameter of the head,
wherein the lower part has an outer diameter larger than the inner diameter of the head and is exposed below the head, and
wherein an operation portion for rotating the coupling member is formed on an outer surface of the lower part.

12. The water filter of claim 1,
wherein a fastening hook is formed at a lower portion of the coupling member, and
wherein a rotation groove configured to receive the fastening hook is formed along a circumference of the filter cap such that the fastening hook moves along the rotation groove when the coupling member rotates.

13. The water filter of claim 12,
wherein a fastening groove extending downward and connected to the rotation groove is formed in the filter cap, and
wherein the fastening hook moves into the rotation groove through the fastening groove.

14. The water filter of claim 13,
wherein a restricting portion protruding farther than the rotation groove is formed at a lower end of the fastening groove so as to restrict the fastening hook inserted into the rotation groove.

15. The water filter of claim 13,
wherein the fastening hook and the fastening groove are disposed in plurality at positions facing each other based on a central axis of the water filter.

16. The water filter of claim 1,
further comprising a rotation member configured to connect the coupling member and the filter cap from outside,
wherein the rotation member is fixedly coupled to the coupling member and rotatably coupled to the filter cap.

17. The water filter of claim 16,
wherein the rotation member is formed by coupling a plurality of portions arranged along circumferences of the filter cap and the coupling member.

18. A home appliance comprising:
a cabinet;
a head provided in the cabinet and connected to a water source; and
a water filter detachably coupled to the head,
wherein the water filter comprises:
a filter member;
a filter housing configured to receive the filter member,
a filter cap configured to seal an opened upper opening of the filter housing and having an inlet portion and an outlet portion protrudingly formed on the filter cap, and
a coupling member rotatably provided on the filter cap and configured to be coupled to the head,
wherein the inlet portion and the outlet portion are configured to, based on the coupling member being rotated relative to the filter cap and the filter housing to be coupled to the head, move upward and connect to a flow path of the head.

19. A method of mounting a water filter, comprising:
aligning the water filter below a head;
inserting a coupling member of the water filter into the head; and
rotating the coupling member relative to a filter housing and a filter cap such that the filter cap moves upward to cause an inlet portion and an outlet portion provided on the filter cap to connect to a flow path of the head.

20. The method of claim 19,
wherein the coupling member stops rotating when an upward movement of the inlet portion and the outlet portion is completed.
